(19) United States
(12) Patent Application Publication
(10) Pub. No.: US 2019/0169351 A1
(43) Pub. Date: Jun. 6, 2019

(54) AMINE CATALYST COMPOSITION FOR PRODUCING HALOALKENE FOAMED POLYURETHANE

(71) Applicant: TOSOH CORPORATION, Shunan-shi, Yamaguchi (JP)

(72) Inventors: Yusuke SESOKO, Shunan-shi, Yamaguchi (JP); Katsumi TOKUMOTO, Shunan-shi, Yamaguchi (JP)

(21) Appl. No.: 16/301,834

(22) PCT Filed: May 16, 2017
(86) PCT No.: PCT/JP2017/018274

§ 371 Date: Nov. 15, 2018

(30) Foreign Application Priority Data
May 17, 2016 (JP) 2016-098772

(51) Int. Cl. C08G 18/18; C08G 18/16; C08G 18/48; C08G 18/42

(52) U.S. Cl. CPC C08G 18/1825; C08G 18/165; C08G 2101/0025; C08G 18/4247; C08G 18/48

(57) ABSTRACT

To provide a catalyst composition which improves storage stability of a polyol blended liquid for producing a polyurethane foam containing a hydrohaloolefin as a blowing agent, and which starts foaming reaction quickly with a small addition amount. Further, to provide a method for producing a polyurethane foam using a polyol blended liquid containing the catalyst composition.

A catalyst composition is used, comprising one or at least two alcohols selected from the group consisting of an alcohol represented by the following formula (1):

R¹—OH (1)

wherein R¹ is a C₅₋₂₀ unsaturated hydrocarbon group having at least one double bond, a C₆, C₈, C₁₀ or C₁₂ linear alkyl group, or a C₁₂₋₂₄ branched alkyl group, and an alcohol represented by the following formula (2):

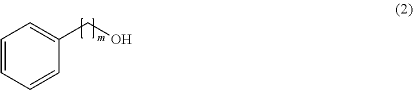

wherein m is from 1 to 4,
and one or at least two tertiary amine compounds selected from the group consisting of hexamethyltriethylenetetramine, N,N,N′-trimethylaminoethylethanolamine, N,N-dimethylaminoethoxyethanol, N,N-dimethyl-N′,N′-di(2-hydroxypropyl)propylenediamine, N,N,N′-trimethyl-N′-(2-hydroxyethyl)bis(2-aminoethyl) ether and N,N-dimethylaminoethyl-N′-methylaminoethyl-N″-methylaminoisopropanol.

### TECHNICAL FIELD

The present invention relates to an amine catalyst composition used when a polyurethane foam is produced. More particularly, it relates to a polyol blended liquid excellent in storage stability, comprising a combination of a polyol, a hydrohaloolefin and a specific amine catalyst composition, and a method for producing a polyurethane foam, which comprises using the polyol blended liquid and an organic polyisocyanate.

### BACKGROUND ART

A polyurethane foam is usually produced by reacting a polyol and a polyisocyanate in the presence of a catalyst and as the case requires, a blowing agent, a surfactant, a crosslinking agent, etc.

In recent years, hydrohaloolefins including hydrofluoroolefins (HFOs) and hydrochlorofluoroolefins (HCFOs) having low global warming potential have been newly proposed as preferred blowing agents. Such hydrofluoroolefins may, for example, be trans-1,3,3,3-tetrafluoropropene (HFO-1234ze) and 1,1,1,4,4,4-hexafluorobut-2-ene (HFO-1336mzz), and hydrochlorofluoroolefins, may, for example, be 1-chloro-3,3,3-trifluoropropene (HCFO-1233zd).

For various applications, it is convenient to preliminarily mix the respective raw material components of the polyurethane foam into a state of a polyol blended liquid. In general, two blend liquid components are prepared.

The first component is composed of a polyisocyanate and a raw material compatible with the polyisocyanate. The other second component (hereinafter referred to as “polyol blended liquid”) is composed of a polyol or a mixture of polyols, a surfactant, a catalyst, a blowing agent and other component reactive or non-reactive with the isocyanate.

Such first component and second component are mixed and subjected to foaming reaction, whereby a favorable polyurethane foam is usually obtained. However, in a case where the second component polyol blended liquid is deteriorated before reacted with the polyisocyanate contained in the first component, the foaming reaction rate may be low, or a polyurethane foam to be formed tends to be inferior in quality. Further, in a case where the deterioration is remarkable, a formed polyurethane foam may collapse before completion of the foaming reaction. The polyol blended liquid may be used after a lapse of several weeks to 3 months after blending, and accordingly it is very important to secure storage stability.

Particularly, a specific hydrohaloolefin including HFO-1234ze and HCFO-1233zd reacts with an amine catalyst usually used for a polyurethane foam and brings about partial decomposition of the hydrohaloolefin, and accordingly the polyol blended liquid has a drawback such as a short storage life. In a case where foaming is conducted using an old polyol blended liquid, the reactivity of the blowing/gelling reaction deteriorates, and cell coarsening of the foam occurs.

To solve such a problem, Patent Document 1 discloses that a favorable polyurethane foam can be formed by adding an organic acid to a polyol blended liquid containing a specific blowing agent such as a hydrohaloolefin including HFO-1234ze and HCFO-1233zd, even when the polyol blended liquid is stored too long.

However, addition of an organic acid does not achieve a sufficient effect to suppress decomposition of the hydrohaloolefin. Accordingly, the storage life of the polyol blended liquid may sometimes be less than several weeks under high temperature conditions such as in summer in which deterioration of the polyol blended liquid as the second component is particularly accelerated. Further, since addition of an organic acid lowers activity of the amine catalyst in the polyol blended liquid, the amount of the catalyst required tends to be large.

As another method to solve the problem, use of a sterically hindered amine as a catalyst to be added to the polyol blended liquid has been known (for example, Patent Document 2). Although the storage life of the second component is extended by use of a sterically hindered amine, since its catalytic activity for the blowing reaction tends to be poor, the foaming reaction will not quickly start at the time of producing a polyurethane foam, dropping may occur in spraying process, and such is a serious problem.

### PRIOR ART DOCUMENTS

### Patent Documents

Patent Document 1: JP-A-2011-500893

Patent Document 2: WO2009/048807

### DISCLOSURE OF INVENTION

### Technical Problem

Under these circumstances, the object of the present invention is to provide a catalyst composition which improves the storage stability of a polyol blended liquid for producing a polyurethane foam containing a hydrohaloolefin as a blowing agent, and which starts foaming reaction quickly with a small addition amount. Further, another object is to provide a method for producing a polyurethane foam, using a polyol blended liquid containing the catalyst composition.

### Solution to Problem

The present inventors have conducted extensive studies to achieve the above objects and as a result, found that a specific amine catalyst composition comprising a combination of a tertiary amine and an alcohol remarkably suppresses decomposition of a hydrohaloolefin while having high catalytic activity, and improves the storage stability of a polyol blended liquid, and accomplished the present invention.

That is, the present invention relates to the following amine catalyst composition for producing a polyurethane foam, polyol blended liquid for producing a polyurethane foam using the amine catalyst composition, and method for producing a polyurethane foam using the polyol blended liquid.

[1] A catalyst composition for producing a polyurethane foam, comprising one or at least two alcohols selected from the group consisting of an alcohol represented by the following formula (1):

R¹—OH (1)

wherein R¹ is a C₅₋₂₀ unsaturated hydrocarbon group having at least one double bond, a C₆, C₈, C₁₀ or C₁₂ linear alkyl group, or a C₁₂₋₂₄ branched alkyl group, and an alcohol represented by the following formula (2):

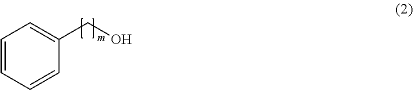

wherein m is from 1 to 4,

and one or at least two tertiary amine compounds selected from the group consisting of hexamethyltriethylenetetramine, N,N,N′-trimethylaminoethylethanolamine, N,N-dimethylaminoethoxyethanol, N,N-dimethyl-N′,N′-di(2-hydroxypropyl)propylenediamine, N,N,N′-trimethyl-N′-(2-hydroxyethyl)bis(2-aminoethyl) ether and N,N-dimethylaminoethyl-N′-methylaminoethyl-N″-methylaminoisopropanol.

[2] The catalyst composition according to the above [1], wherein R¹ in the formula (1) is a C₅, C₁₀ or C₁₈ unsaturated hydrocarbon group having at least one double bond.
[3] The catalyst composition according to the above [1] or [2], wherein the alcohol represented by the formula (1) is at least one member selected from the group consisting of oleyl alcohol, linoleyl alcohol, linolenyl alcohol, prenol, linalool, α-terpineol, 1-hexanol, 1-octanol, 1-decanol, lauryl alcohol, 2-butyloctanol, 2-hexyldecanol, stearyl alcohol, isostearyl alcohol, 2-octyldecanol, 2-octyldodecanol, isoeicosanol and 2-decyltetradecanol.
[4] The catalyst composition according to any one of the above [1] to [3], wherein the alcohol represented by the formula (1) is at least one member selected from the group consisting of oleyl alcohol, linoleyl alcohol, linolenyl alcohol, 1-octanol, 1-decanol, lauryl alcohol, 2-hexyldecanol, isostearyl alcohol, 2-octyldodecanol, isoeicosanol and 2-decyltetradecanol.
[5] The catalyst composition according to any one of the above [1] to [4], wherein the alcohol represented by the formula (1) is at least one member selected from the group consisting of oleyl alcohol, 1-decanol, lauryl alcohol, isostearyl alcohol, isoeicosanol and 2-decyltetradecanol.
[6] The catalyst composition according to any one of the above [1] to [5], wherein the alcohol represented by the formula (2) is benzyl alcohol.
[7] The catalyst composition according to any one of the above [1] to [6], wherein the tertiary amine compound is one or at least two compounds selected from the group consisting of hexamethyltriethylenetetramine, N,N,N′-trimethylaminoethylethanolamine and N,N-dimethylaminoethoxyethanol.
[8] The catalyst composition according to any one of the above [1] to [6], wherein the tertiary amine compound is one or two compounds selected from the group consisting of hexamethyltriethylenetetramine and N,N,N′-trimethylaminoethylethanolamine.
[9] A polyol blended liquid composition for producing a polyurethane foam, which comprises a polyol, a hydrohaloolefin and the catalyst composition as defined in any one of the above [1] to [8].
[10] The polyol blended liquid composition according to the above [9], wherein the hydrohaloolefin is a fluoroalkene or chloroalkene having 3 or 4 carbon atoms.
[11] The polyol blended liquid composition according to the above [9] or [10], wherein the hydrohaloolefin is one or at least two members selected from the group consisting of trifluoropropene, tetrafluoropropene, pentafluoropropene, chlorodifluoropropene, chlorotrifluoropropene and chlorotetrafluoropropene.
[12] The polyol blended liquid composition according to any one of the above [9] to [11], wherein the hydrohaloolefin is one or at least two compounds selected from the group consisting of 1,3,3,3-tetrafluoropropene, 1,1,3,3-tetrafluoropropene, 1,2,3,3,3-pentafluoropropene, 1,1,1-trifluoropropene, 1,1,1,3,3-pentafluoropropene, 1,1,1,3,3,3-hexafluorobut-2-ene, 1,1,2,3,3-pentafluoropropene, 1,1,1,2,3-pentafluoropropene, 1-chloro-3,3,3-trifluoropropene, 1,1,1,4,4,4-hexafluorobut-2-ene, and their structural isomers, geometric isomers and stereoisomers.
[13] The polyol blended liquid composition according to any one of the above [1] to [12], wherein the polyol is at least one member selected from the group consisting of a polyether and a polyester polyol, having an average hydroxy value of from 200 to 800 mgKOH/g.
[14] A method for producing a polyurethane foam, which comprises reacting the polyol blended liquid composition as defined in any one of the above [9] to [13], and a polyisocyanate.

### Advantageous Effects of Invention

catalyst composition of the present invention is, surprisingly, capable of remarkably increasing storage stability of a polyol blended liquid for producing a polyurethane foam containing a hydrohaloolefin, although it is not to neutralize an amine compound.

Further, the catalyst composition of the present invention, which has remarkably high blowing and gelling catalytic activity as compared with an organic acid-containing amine catalyst, exhibits sufficient reactivity even with a small addition amount, in production of a polyurethane foam using a hydrohaloolefin as a blowing agent.

Further, the catalyst composition of the present invention, which has remarkably high blowing activity as compared with a sterically hindered amine, can start foaming reaction quickly, and prevents dripping in spraying process.

From the above reasons, by using the catalyst composition of the present invention, a polyol blended liquid can be stored for a long period of time, and a favorable haloalkene foamed polyurethane can be produced.

### DESCRIPTION OF EMBODIMENTS

The catalyst composition for producing a polyurethane foam of the present invention comprises one or at least two alcohols selected from the group consisting of an alcohol represented by the above formula (1) and an alcohol represented by the above formula (2), and one or at least two tertiary amine compounds selected from the group consisting of hexamethyltriethylenetetramine, N,N,N′-trimethylaminoethylethanolamine, N,N-dimethylaminoethoxyethanol, N,N-dimethyl-N′,N′-di(2-hydroxypropyl)propylenediamine, N,N,N′-trimethyl-N′-(2-hydroxyethyl)bis(2-aminoethyl) ether and N,N-dimethylaminoethyl-N′-methylaminoethyl-N″-methylaminoisopropanol.

In the alcohol represented by the formula (1), as R¹, the C₅₋₂₀ unsaturated hydrocarbon group having at least one double bond is not particularly limited and from the viewpoint of availability, preferably a C₅, C₁₀ or C₁₈ unsaturated hydrocarbon group having at least one double bond. Such an alcohol is not particularly limited and may, for example, be oleyl alcohol, linoleyl alcohol, linolenyl alcohol, prenol, linalool or α-terpineol. With a view to improving storage stability of a polyol blended liquid composition for producing a polyurethane foam containing a hydrohaloolefin, preferred is oleyl alcohol, linoleyl alcohol or linolenyl alcohol, particularly preferred is oleyl alcohol.

In the alcohol represented by the formula (1), as R¹, the C₆, C₈, C₁₀ or C₁₂ linear alkyl group may, for example, be 1-hexanol, 1-octanol, 1-decanol or lauryl alcohol. With a view to improving storage stability of the polyol blended liquid for producing a polyurethane foam containing a hydrohaloolefin, preferred is 1-octanol, 1-decanol or lauryl alcohol, particularly preferred is 1-decanol or lauryl alcohol.

In the alcohol represented by the formula (1), as R¹, the C₁₂₋₂₄ branched alkyl group is not particularly limited and may, for example, be 2-butyloctanol, 2-hexyldecanol, stearyl alcohol, isostearyl alcohol, 2-octyldecanol, 2-octyldodecanol, isoeicosanol or 2-decyltetradecanol. With a view to improving storage stability of a polyol blended liquid for producing a polyurethane foam containing a hydrohaloolefin and from the viewpoint of availability, preferred is 2-hexyldecanol, isostearyl alcohol, 2-octyldodecanol, isoeicosanol or 2-decyltetradecanol, particularly preferred is isostearyl alcohol, isoeicosanol or 2-decyltetradecanol.

The alcohol represented by the formula (2) may, for example, be benzyl alcohol, 2-phenylethyl alcohol, 3-phenylpropyl alcohol or 4-phenylbutyl alcohol. From the viewpoint of availability, preferred is benzyl alcohol or 2-phenylethylalcohol, particularly preferred is benzyl alcohol.

The tertiary amine compound is not particularly limited so long as it is one or at least two compounds selected from the group consisting of hexamethyltriethylenetetramine, N,N,N′-trimethylaminoethylethanolamine, N,N-dimethylaminoethoxyethanol, N,N-dimethyl-N′,N′-di(2-hydroxypropyl)propylenediamine, N,N,N′-trimethyl-N′-(2-hydroxyethyl)bis(2-aminoethyl) ether and N,N-dimethylaminoethyl-N′-methylaminoethyl-N″-methylaminoisopropanol. With a view to improving storage stability of the polyol blended liquid for producing a polyurethane foam containing a hydrohaloolefin, preferred is hexamethyltriethylenetetramine, N,N,N′-trimethylaminoethylethanolamine or N,N-dimethylaminoethoxyethanol. Further, from the viewpoint of the catalytic activity, particularly preferred is hexamethyltriethylenetetramine or N,N,N′-trimethylaminoethylethanolamine.

The content ratio of the alcohol to the tertiary amine compound is not particularly limited, and the ratio of alcohol/tertiary amine compound is preferably within a ratio of from 90/20 to 10/90 (weight ratio), more preferably within a range of from 80/20 to 20/80 (weight ratio), particularly preferably from 70/30 to 30/70 (weight ratio).

The tertiary amine compound may easily be produced by a method known in the literature. For example, it may be produced e.g. by reaction of a diol and a diamine, by amination of an alcohol, by reductive methylation of a monoaminoalcohol or a diamine, or by reaction of an amine compound and an alkylene oxide.

The catalyst composition of the present invention may be used in combination with a catalyst other than the tertiary amine compound, within a range not to depart from the scope of the present invention. Such a catalyst may, for example, be a known organic metal catalyst or quaternary ammonium salt catalyst.

The organic metal catalyst may, for example, be stannous diacetate, stannous dioctoate, stannous dioleate, stannous dilaurate, dibutyltin oxide, dibutyltin diacetate, dibutyltin dilaurate, dibutyltin dichloride, dioctyltin dilaurate, lead octanate, lead naphthenate, nickel naphthenate or cobalt naphthenate.

The quaternary ammonium salt catalyst may, for example, be a tetraalkylammonium halide such as tetramethylammonium chloride, a tetraalkylammonium hydroxide such as tetramethylammonium hydroxide, a tetraalkylammonium organic acid salt such as tetramethylammonium acetate or tetramethylammonium 2-ethylhexanoate, or a hydroxyalkylammonium organic acid salt such as 2-hydroxypropyltrimethylammonium formate or 2-hydroxypropyltrimethylammonium 2-ethylhexanoate.

For the catalyst composition of the present invention, the tertiary amine compound may be used alone or as mixed with other catalyst. For preparation by mixing, as the case requires, as a solvent, dipropylene glycol, ethylene glycol, 1,4-butanediol, water or the like may be used. The amount of the solvent is not particularly limited and is preferably at most 70 wt % based on the entire amount of the catalyst composition.

The polyol blended liquid composition for producing a polyurethane foam of the present intention comprises a polyol, a hydrohaloolefin and the above-described catalyst composition of the present invention.

In the polyol blended liquid composition of the present invention, the amount of the catalyst composition of the present invention is, per 100 parts by weight of the polyol used, usually from 0.1 to 100 parts by weight, preferably from 0.1 to 50 parts by weight, more preferably from 0.1 to 10 parts by weight. If the amount of the tertiary amine compound is increased, although curing property and productivity of a polyurethane resin will improve, the amount of volatile amines also increases, and such is unfavorable.

Further, in the catalyst composition of the present invention, in a case where a catalyst other than the tertiary amine compound is used in combination, its amount in the polyol blended liquid composition of the present invention is not particularly limited and is usually from 0.1 to 100 parts by weight per 100 parts by weight of the polyol used.

The hydrohaloolefin to be used in the polyol blended liquid composition of the present invention functions as a blowing agent for producing a polyurethane foam. The hydrohaloolefin has global warming potential (GWP) of at most 150, preferably at most 100, more preferably at most 75.

Here, “GWP” is measured relative to GWP of carbon dioxide in 100 years scale as defined in “The Scientific Assessment of Ozone Depletion, 2002, a report of the World Meteorological Association's Global Ozone Research and Monitoring Project”.

Further, the hydrohaloolefin has ozone depletion potential (ODP) of preferably at most 0.05, more preferably at most 0.02, further preferably about 0.

Here, “ODP” is as defined in “The Scientific Assessment of Ozone Depletion, 2002, A report of the World Meteorological Association's Global Ozone Research and Monitoring Project”.

The hydrohaloolefin used for the polyol blended liquid composition of the present invention is not particularly limited, however, at least one compound selected from at least one haloalkene such as a C₃ or C₄ fluoroalkene or chloroalkene is preferably contained. Such a hydrohaloolefin is not particularly limited and may, for example, be trifluoropropene, tetrafluoropropene, pentafluoropropene, chlorotrifluoropropene, chlorodifluoropropene or chlorotetrafluoropropene. In the present invention, they may be used alone or in combination.

The hydrohaloolefin used for the polyol blended liquid composition of the present invention is more preferably tetrafluoropropene, pentafluoropropene or chlorotrifluoropropene, in which the unsaturated terminal carbon has at most one F or Cl substituent. Such a compound may, for example, be one or at least two compounds selected from the group consisting of 1,3,3,3-tetrafluoropropene (HFO-1234ze), 1,1,3,3-tetrafluoropropene, 1,2,3,3,3-pentafluoropropene (HFO-1225ye), 1,1,1-trifluoropropene, 1,1,1,3,3-pentafluoropropene (HFO-1225zc), 1,1,1,3,3,3-hexafluorobut-2-ene, 1,1,2,3,3-pentafluoropropene (HFO-1225yc), 1,1,1,2,3-pentafluoropropene (HFO-1225yez), 1-chloro-3,3,3-trifluoropropene (HFCO-1233zd), 1,1,1,4,4,4-hexafluorobut-2-ane (HFO-1336mzz), and their structural isomers, geometric isomers and stereoisomers. In view of heat insulating property and availability, particularly preferred is trans-1-chloro-3,3,3-trifluoropropene (HFCO-1233zd(E)).

For the polyol blended liquid composition of the present invention, in addition to the hydrohaloolefin, a known blowing agent may be used within a range not to depart from the scope of the present invention. Such a blowing agent is not particularly limited and may, for example, be water, formic acid, an organic acid which generates CO₂ upon reaction with an isocyanate, a hydrocarbon, an ether, a halogenated ether, pentafluorobutane, pentafluoropropane, hexafluoropropane, heptafluoropropane, trans-1,2-dichloroethylene, methyl formate, 1-chloro-1,2,2,2-tetrafluoroethane, 1,1-dichloro-1-fluoroethane, 1,1,1,2-tetrafluoroethane, 1,1,2,2-tetrafluoroethane, 1-chloro-1,1-difluoroethane, 1,1,1,3,3-pentafluorobutane, 1,1,1,2,3,3,3-heptafluoropropane, trichlorofluoromethane, dichlorodifluoromethane, 1,1,1,3,3,3-hexafluoropropane, 1,1,1,2,3,3-hexafluoropropane, difluoromethane, difluoroethane, 1,1,1,3,3-pentafluoropropane, 1,1-difluoroethane, isobutane, n-pentane, isopentane or cyclopentane. In the present invention, they may be used alone or in combination.

In the polyol blended liquid composition of the present invention, the amount of the blowing agent component is usually from 1 to 50 wt %, preferably from 3 to 30 wt %, more preferably from 5 to 20 wt % of the weight of the polyol blended liquid composition.

In a case where the polyol blended liquid composition of the present invention contains both hydrohaloolefin and other blowing agent, the hydrohaloolefin is present in the blowing agent component in an amount of usually from 5 to 90 wt %, preferably from 7 to 80 wt %, more preferably from 10 to 70 wt % of the weight of the blowing agent component, and other blowing agent is present in the blowing agent component in an amount of usually from 95 to 10 wt %, preferably from 93 to 20 wt %, more preferably from 90 to 30 wt % of the weight of the blowing agent component.

The polyol may, for example, be a known polyester polyol, polyether polyol or polymer polyol, and in the present invention, they may be used alone or in combination.

The polyester polyol is not particularly limited and may, for example, be one obtained by reaction of a dibasic acid and a glycol, waste generated in production of nylon, waste from trimethylolpropane or pentaerythritol, waste of a phthalate polyester, or a polyester polyol derived by treating waste [for example, “Polyurethane Resin Handbook”, Keiji Iwata, 1987, The Nikkan Kogyo Shimbun Ltd., p. 117].

The polyether polyol is not particularly limited and may, for example, be one produced by addition reaction of a compound having at least two active hydrogen groups (for example, a polyhydric alcohol such as ethylene glycol, propylene glycol, glycerin, trimethylolpropane or pentaerythritol, an amine such as ethylenediamine, or an alkanolamine such as ethanolamine or diethanolamine) as a starting material with an alkylene oxide (such as ethylene oxide or propylene oxide) [for example, method disclosed in Gunter Oertel, “Polyurethane Handbook”, 1985, Hanser Publishers (Germany), p. 42 to 53].

The polymer polyol may, for example, be a polymer polyol obtained by reacting a polyether polyol and an ethylenic unsaturated monomer (such as butadiene, acrylonitrile or styrene) in the presence of a radical polymerization catalyst.

Among them, for production of the after-described rigid polyurethane foam, the polyol is preferably at least one polyol selected from the group consisting of a polyether and a polyester polyol. The average functionality of the polyol is preferably from 4 to 8, and the average hydroxy value is preferably from 200 to 800 mgKOH/g, more preferably from 300 to 700 mgKOH/g.

As a foam stabilizer used as the case requires in the polyol blended liquid composition of the present invention, for example, a known silicone foam stabilizer may be mentioned, and specifically, a nonionic surfactant such as an organosiloxane/polyoxyalkylene copolymer or a silicone/grease copolymer may, for example, be mentioned. In the present invention, they may be used alone or in combination. The amount of the foam stabilizer is usually 0.1 to 10 parts by weight per 100 parts by weight of the polyol.

In the polyol blended liquid composition of the present invention, as the case requires, a crosslinking agent or a chain extender may be added. The crosslinking agent or the chain extender may, for example, be a low molecular weight polyhydric alcohol such as ethylene glycol, diethylene glycol, 1,4-butanediol or glycerin, a low molecular weight amine polyol such as diethanolamine or triethanolamine, or a polyamine such as ethylenediamine, xylylenediamine or methylenebisorthochloroaniline.

Further, for the polyol blended liquid composition of the present invention, as the case requires, a coloring agent, a flame retardant, an antioxidant or other additive may be used. The type and the amount of such an additive may be within usual ranges.

The polyol blended liquid composition of the present invention may be used for producing a polyurethane foam without any particular restriction, and is particularly suitably used for producing a rigid polyurethane foam and an isocyanurate-modified rigid polyurethane foam.

In the present invention, the rigid polyurethane foam means an irreversible foam having a highly crosslinked closed cell structure, as disclosed in Gunter Oertel, “Polyurethane Handbook”, 1985, Hanser Publishers (Germany), p. 234 to 313, or “Polyurethane Resin Handbook”, Keiji Iwata, 1987, first edition, The Nikkan Kogyo Shimbun Ltd., p. 224 to 283. Physical properties of the rigid urethane foam are not particularly limited, and usually, the density is from 10 to 100 kg/m³, and the compressive strength is 50 to 1,000 kPa.

The method for producing a polyurethane foam of the present invention comprises reacting the polyol blended liquid composition of the present invention and a polyisocyanate.

The polyisocyanate is not particularly limited and may, for example, be an aromatic polyisocyanate such as toluene diisocyanate (TDI), 4,4′- or 4,2′-diphenylmethane diisocyanate (MDI), naphthylene diisocyanate or xylylene diisocyanate, an alicyclic polyisocyanate such as isophorone diisocyanate, an aliphatic polyisocyanate such as hexamethylene diisocyanate, or a free isocyanate-containing prepolymer obtained by reaction of such an isocyanate and a polyol, a modified polyisocyanate such as a carbodiimide-modified polyisocyanate, or a mixed polyisocyanate thereof.

As TDI and its derivative, for example, a mixture of 2,4-TDI and 2,6-TDI, or a terminal isocyanate prepolymer derivative of TDI may be mentioned.

As MDI and its derivative, for example, a mixture of MDI and polyphenyl polymethylene diisocyanate of its polymer, or diphenylmethane diisocyanate derivative having a terminal isocyanate group may be mentioned.

Among them, for the rigid polyurethane foam, MDI or a derivative of MDI is preferably used, and they may be used as mixed.

A polyurethane foam product produced by using the polyol blended liquid composition of the present invention may be used for various applications. For example, in the case of a rigid polyurethane foam, its application may be a heat insulating building material, or a foam for a freezer, a refrigerator, etc.

### EXAMPLES

Now, the present invention will be described in further detail with reference to Examples and Comparative Examples. However, it should be understood that the present invention is by no means restricted to such specific Examples.

In the following Examples and Comparative Examples, methods for measuring respective items are as follows.

### Examples 1 to 27 and Comparative Examples 1 to 5

Based on a polyol blended liquid containing a polyol, a foam stabilizer, a catalyst composition, water and a hydrohaloolefin as identified in Table 1 or 2, the weight ratio of a polyisocyanate was determined so as to achieve a predetermined isocyanate index, and liquid temperatures of both the components were adjusted at 20° C., and they were mixed with stirring by using a labo mixer at 7,000 rpm for 3 seconds to conduct foaming reaction thereby to produce a rigid polyurethane foam. The addition amount of the amine catalyst composition was adjusted so that the gel time would be from 29 to 40 seconds.

The cream time (CT) and the gel time (GT) on that occasion were visually measured and taken as the initial reactivity. The cream time and the gel time as identified in Tables 1 and 2 were defined as follows.

Cream time: the time when, as the blowing reaction proceeded, foaming started was measured.

Gel time: the time when, as the gelling reaction proceeded, the liquid substance changed into a resinous substance was measured.

Further, of the obtained rigid polyurethane foam, the outer appearance was confirmed, and the state of the cell and whether collapse occurred or not was recorded.

Further, a center portion of the obtained rigid polyurethane foam was sampled, and its dimensions and weight were measured to determine the foam density.

Then, a polyol blended liquid containing the amine catalyst composition, a blowing agent, a polyol, a foam stabilizer and further containing water was put in a closed container and heated at 40° C. for 7 days, and in the same manner as evaluation of the initial reactivity, CT and GT when mixed with a polyisocyanate at liquid temperature of 20° C. and subjected to foaming reaction, were measured and taken as the reactivity after storage.

Further, of the obtained rigid polyurethane foam, the outer appearance was confirmed, and a state of the cell and whether collapse occurred or not were recorded and further, the foam density after storage was measured.

The results are shown in Tables 1 and 2.

TABLE 1

| Raw | Polyol A (parts by weight) | | | 1) |
|---|---|---|---|---|
| material | Polyol B (parts by weight) | | | 2) |
| blended | Polyol C (parts by weight) | | | 3) |
| liquid | Foam stabilizer (parts by weight) | | | 4) |
| (parts by | Catalyst | (Compound) | | |
| weight) | composition | Alcohol | Oleyl alcohol | 5) |
| | | | Prenol | 5) |
| | | | Linalool | 5) |
| | | | α-terpineol | 5) |
| | | | 1-octanol | 5) |
| | | | 1-decanol | 5) |
| | | | Isostearyl alcohol | 6) |
| | | | Isostearyl alcohol | 7) |
| | | | 2-octyldodecanol | 8) |
| | | | Isoeicosanol | 9) |
| | | | 2-decyltetradecanol | 10) |
| | | | Benzyl alcohol | 5) |
| | | | 4-phenylbutyl alcohol | 5) |
| | | Organic acid | Formic acid | 3) |
| | | Tertiary | Hexamethyltriethylenetetramin | 11) |
| | | amine | N,N,N′-trimethylaminoethylethanolamine | 12) |
| | | compound | N,N-dicyclohexylmethylamine | 5) |

| | | |
|---|---|---|
| Blowing | Hydrohaloolefin | 13) |

| | |
|---|---|
| agent | Water |

| | |
|---|---|
| Polyisocyanate, isocyanate index | 14) |

| | |
|---|---|
| Initial reactivity | CT (sec) |
| | GT (sec) |
| Reactivity after storage | CT (sec) |
| | GT (sec) |
| Rate of change of GT | (%) |
| Foam density before storage | (kg/m³) |
| Foam density after storage | (kg/m³) |
| Rate of change of foam density | (%) |

Outer appearance of foam from blended liquid after storage
Degree of cell coarsening of foam from blended liquid after storage

Examples

| 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|
| 100 | 100 | 100 | 100 | 100 | 100 | 100 | 100 | 100 | 100 | 100 | 100 | 100 | 100 | 100 |
| — | — | — | — | — | — | — | — | — | — | — | — | — | — | — |
| — | — | — | — | — | — | — | — | — | — | — | — | — | — | — |
| 1.0 | 1.0 | 1.0 | 1.0 | 1.0 | 1.0 | 1.0 | 1.0 | 1.0 | 1.0 | 1.0 | 1.0 | 1.0 | 1.0 | 1.0 |
| 6.2 | — | — | — | — | — | — | — | — | — | — | — | — | — | — |
| — | 6.2 | — | — | — | — | — | — | — | — | — | — | — | — | — |
| — | — | 6.2 | — | — | — | — | — | — | — | — | — | — | — | — |
| — | — | — | 6.2 | — | — | — | — | — | — | — | — | — | — | — |
| — | — | — | — | 6.2 | — | — | — | — | — | — | — | — | — | — |
| — | — | — | — | — | 3.1 | 6.2 | 9.3 | — | — | — | — | — | — | — |
| — | — | — | — | — | — | — | — | 6.2 | — | — | — | — | — | — |
| — | — | — | — | — | — | — | — | — | 6.2 | — | — | — | — | — |
| — | — | — | — | — | — | — | — | — | — | 6.2 | — | — | — | — |
| — | — | — | — | — | — | — | — | — | — | — | 6.2 | — | — | — |
| — | — | — | — | — | — | — | — | — | — | — | — | 6.2 | — | — |
| — | — | — | — | — | — | — | — | — | — | — | — | — | 6.2 | — |
| — | — | — | — | — | — | — | — | — | — | — | — | — | — | 6.2 |
| — | — | — | — | — | — | — | — | — | — | — | — | — | — | — |
| 4.5 | 4.5 | 4.5 | 4.5 | 4.5 | 4.5 | 4.5 | 4.5 | 4.5 | 4.5 | 4.5 | 4.5 | 4.5 | 4.5 | 4.5 |
| — | — | — | — | — | — | — | — | — | — | — | — | — | — | — |
| — | — | — | — | — | — | — | — | — | — | — | — | — | — | — |
| 15.0 | 15.0 | 15.0 | 15.0 | 15.0 | 15.0 | 15.0 | 15.0 | 15.0 | 15.0 | 15.0 | 15.0 | 15.0 | 15.0 | 15.0 |
| 2.0 | 2.0 | 2.0 | 2.0 | 2.0 | 2.0 | 2.0 | 2.0 | 2.0 | 2.0 | 2.0 | 2.0 | 2.0 | 2.0 | 2.0 |
| 100 | 100 | 100 | 100 | 100 | 100 | 100 | 100 | 100 | 100 | 100 | 100 | 100 | 100 | 100 |
| 6 | 6 | 6 | 5 | 6 | 5 | 5 | 5 | 5 | 5 | 5 | 5 | 5 | 6 | 6 |
| 34 | 34 | 40 | 40 | 32 | 34 | 34 | 34 | 35 | 34 | 33 | 34 | 34 | 34 | 34 |
| 7 | 6 | 6 | 5 | 7 | 6 | 6 | 6 | 5 | 5 | 5 | 5 | 5 | 6 | 6 |
| 35 | 34 | 40 | 40 | 35 | 35 | 35 | 35 | 35 | 34 | 33 | 34 | 34 | 35 | 34 |
| 3 | 0 | 0 | 0 | 9 | 3 | 3 | 3 | 0 | 0 | 0 | 0 | 0 | 3 | 0 |
| 35 | 36 | 37 | 31 | 36 | 35 | 36 | 37 | 36 | 36 | 36 | 36 | 36 | 36 | 36 |
| 37 | 41 | 39 | 34 | 39 | 45 | 37 | 37 | 36 | 37 | 36 | 38 | 36 | 42 | 39 |
| 5 | 16 | 6 | 8 | 8 | 28 | 2 | 0 | 0 | 3 | 0 | 5 | 0 | 15 | 8 |
| G | G | G | G | G | G | G | G | G | G | G | G | G | G | G |
| VL | L | L | L | L | M | L | VL | VL | VL | VL | VL | VL | L | VL |

G: good,
VL: very little,
L: little,
M: Medium

TABLE 2

| Raw | Polyol A (parts by weight) | | | 1) |
|---|---|---|---|---|
| material | Polyol B (parts by weight) | | | 2) |
| blended | Polyol C (parts by weight) | | | 3) |
| liquid | Foam stabilizer (parts by weight) | | | 4) |
| (parts by | Catalyst | (Compound) | | |
| weight) | composition | Alcohol | Oleyl alcohol | 5) |
| | | | Prenol | 5) |
| | | | Linalool | 5) |
| | | | α-terpineol | 5) |
| | | | 1-octanol | 5) |
| | | | 1-decanol | 5) |
| | | | Isostearyl alcohol | 6) |
| | | | Isostearyl alcohol | 7) |
| | | | 2-octyldodecanol | 8) |
| | | | Isoeicosanol | 9) |
| | | | 2-decyltetradecanol | 10) |
| | | | Benzyl alcohol | 5) |
| | | | 4-phenylbutyl alcohol | 5) |
| | | Organic acid | Formic acid | 3) |
| | | Tertiary | Hexamethyltriethylenetetramin | 11) |
| | | amine | N,N,N′-trimethylaminoethylethanolamine | 12) |
| | | compound | N,N-dicyclohexylmethylamine | 5) |

| | | |
|---|---|---|
| Blowing | Hydrohaloolefin | 13) |

| | |
|---|---|
| agent | Water |

| | |
|---|---|
| Polyisocyanate, isocyanate index | 14) |

| | |
|---|---|
| Initial reactivity | CT (sec) |
| | GT (sec) |
| Reactivity after storage | CT (sec) |
| | GT (sec) |
| Rate of change of GT | (%) |
| Foam density before storage | (kg/m³) |
| Foam density after storage | (kg/m³) |
| Rate of change of foam density | (%) |

Outer appearance of foam from blended liquid after storage
Degree of cell coarsening of foam from blended liquid after storage

Examples

| 16 | 17 | 18 | 19 | 20 | 21 | 22 | 23 | 24 | 25 | 26 | 27 |
|---|---|---|---|---|---|---|---|---|---|---|---|
| 100 | 100 | 100 | 100 | 100 | 100 | 100 | 100 | — | — | — | — |
| — | — | — | — | — | — | — | — | 100 | — | — | — |
| — | — | — | — | — | — | — | — | — | 100 | 100 | 100 |
| 1.0 | 1.0 | 1.0 | 1.0 | 1.0 | 1.0 | 1.0 | 1.0 | 1.0 | 1.0 | 1.0 | 1.0 |
| 6.2 | — | — | — | — | — | — | — | — | 7.4 | — | — |
| — | — | — | — | — | — | — | — | — | — | — | — |
| — | — | — | — | — | — | — | — | — | — | — | — |
| — | — | — | — | — | — | — | — | — | — | — | — |
| — | — | — | — | — | — | — | — | — | — | — | — |
| — | 6.2 | — | — | — | — | — | — | — | — | — | — |
| — | — | 6.2 | — | — | — | — | — | — | — | 4.0 | 1.7 |
| — | — | — | 6.2 | — | — | — | — | — | — | — | — |
| — | — | — | — | 6.2 | — | — | — | — | — | — | — |
| — | — | — | — | — | 6.2 | — | — | — | — | — | — |
| — | — | — | — | — | — | 6.2 | — | — | — | — | — |
| — | — | — | — | — | — | — | 6.2 | 2.2 | — | — | — |
| — | — | — | — | — | — | — | — | — | — | — | — |
| — | — | — | — | — | — | — | — | — | — | — | — |
| — | — | — | — | — | — | — | — | — | — | — | — |
| 7.3 | 7.3 | 7.3 | 7.3 | 7.3 | 7.3 | 7.3 | 7.3 | 2.2 | 4.0 | 4.0 | 4.0 |
| — | — | — | — | — | — | — | — | — | — | — | — |
| 15.0 | 15.0 | 15.0 | 15.0 | 15.0 | 15.0 | 15.0 | 15.0 | 15.0 | 15.0 | 15.0 | 15.0 |
| 2.0 | 2.0 | 2.0 | 2.0 | 2.0 | 2.0 | 2.0 | 2.0 | 2.0 | 2.0 | 2.0 | 2.0 |
| 100 | 100 | 100 | 100 | 100 | 100 | 100 | 100 | 110 | 110 | 110 | 110 |
| 5 | 6 | 5 | 5 | 5 | 5 | 6 | 5 | 6 | 6 | 6 | 6 |
| 30 | 30 | 30 | 29 | 30 | 30 | 31 | 30 | 18 | 12 | 13 | 12 |
| 5 | 7 | 5 | 5 | 5 | 5 | 6 | 5 | 6 | 8 | 8 | 8 |
| 32 | 31 | 32 | 31 | 33 | 33 | 34 | 31 | 20 | 16 | 15 | 15 |
| 7 | 3 | 7 | 7 | 10 | 10 | 10 | 3 | 6 | 28 | 21 | 22 |
| 32 | 34 | 32 | 32 | 32 | 33 | 33 | 33 | 28 | 31 | 32 | 31 |
| 32 | 35 | 33 | 32 | 32 | 33 | 33 | 34 | 28 | 31 | 32 | 31 |
| 2 | 1 | 3 | 1 | 1 | 1 | 2 | 3 | 0 | 0 | 0 | 0 |
| G | G | G | G | G | G | G | G | G | G | G | G |
| VL | VL | VL | VL | VL | VL | VL | VL | VL | VL | VL | VL |

Comparative Examples

| 1 | 2 | 3 | 4 | 5 |
|---|---|---|---|---|
| 100 | 100 | 100 | — | — |
| — | — | — | 100 | — |
| — | — | — | — | 100 |
| 1.0 | 1.0 | 1.0 | 1.0 | 1.0 |
| — | — | — | — | — |
| — | — | — | — | — |
| — | — | — | — | — |
| — | — | — | — | — |
| — | — | — | — | — |
| — | — | — | — | — |
| — | — | — | — | — |
| — | — | — | — | — |
| — | — | — | — | — |
| — | — | — | — | — |
| — | — | — | — | — |
| — | — | — | — | — |
| — | — | — | — | — |
| — | — | — | — | — |
| — | 8.0 | — | — | — |
| 4.5 | 10.0 | — | — | — |
| — | — | — | 2.2 | 4.0 |
| — | — | 11.4 | — | — |
| 15.0 | 15.0 | 15.0 | 15.0 | 15.0 |
| 2.0 | 2.0 | 2.0 | 2.0 | 2.0 |
| 100 | 100 | 100 | 110 | 110 |
| 5 | 5 | 14 | 6 | 6 |
| 34 | 40 | 34 | 18 | 12 |
| 8 | 5 | 14 | 7 | 8 |
| 38 | 42 | 34 | 22 | 20 |
| 12 | 5 | 0 | 20 | 64 |
| 35 | 33 | 34 | 28 | 31 |
| 81 | 56 | 34 | 30 | 32 |
| 131 | 69 | 0 | 8 | 1 |
| Collapsed | Partly collapsed | G | G | G |
| Significant | Significant | L | L | L |

G: good,
VL: very little,
L: little,
M: Medium

In Tables 1 and 2, 1) to 14) are as follows.

1): Sannix HS-209 (polyether polyol manufactured by Sanyo Chemical Industries, Ltd., OH value: 447 mgKOH/g)

2): DK POLYOL 3776 (Mannich type polyether polyol manufactured by DKS Co., Ltd., OH value: 357 mgKOH/g)

3): MAXIMOL RDK-133 (aromatic polyester polyol manufactured by Kawasaki Kasei Chemicals Ltd., OH value: 316 mgKOH/g)

4): Niax-L-5420 (silicone surfactant manufactured by Momentive)

5): Reagent manufactured by Tokyo Chemical Industry Co., Ltd.

6): FINEOXOCOL 180 manufactured by Nissan Chemical Industries, Ltd.

7): FINEOXOCOL 180N manufactured by Nissan Chemical Industries, Ltd.

8): Reagent manufactured by Aldrich

9): FINEOXOCOL 2000 manufactured by Nissan Chemical Industries, Ltd.

10): NJCOL 240A manufactured by New Japan Chemical Co., Ltd.

11): Product prepared by reductive methylation of triethylenetetramine with formaline

12): TOYOCAT-RX5 (manufactured by Tosoh Corporation)

13): Trans-1-chloro-3,3,3-trifluoropropene (Solstice-LBA manufactured by Honeywell)

14): Polymeric MDI (Millionate MR200, manufactured by Tosoh Corporation, NCO content: 31.0%)

As evident from Tables 1 and 2, in Examples 1 to 23 in which the amine catalyst composition of the present invention prepared by using an alcohol and a tertiary amine compound in combination was used, CT before storage was short, and the foaming reaction started quickly. The decrease in reactivity after storage was small, and the rate of change of GT was at most 10% in each Example. Further, an increase of the foam density was suppressed, and the foam density change rate was less than 30%. The outer appearance of the obtained rigid polyurethane foam and the degree of cell coarsening are within favorable ranges.

Whereas in Comparative Examples 1 to 3 in which an alcohol, which is contained in the amine catalyst composition of the present invention, was not used, a decrease of the reactivity after storage was significant.

The rigid polyurethane foam obtained in Comparative Example 1 collapsed during the foaming reaction, and it cannot be used practically.

In Comparative Example 2 in which a conventional mixture of an organic acid and an amine was used as a catalyst, although a decrease of the reactivity was not significant, the foam partly collapsed during the foaming reaction. Further, the obtained rigid polyurethane foam had severe cell coarsening. Further, since the catalyst had low catalytic activity, the amount of the catalyst required was large as compared with Examples 1 to 23.

In Comparative Example 3 in which a conventional sterically hindered amine was used as a catalyst, no decrease of the reactivity was observed, and the obtained foam had a favorable outer appearance, however, CT was very long since the catalytic activity for the blowing reaction was low.

Then, Examples in which a Mannich type polyether polyol was used instead of the polyether polyol used in Examples 21 to 23 will be described.

In Example 24 in which the amine catalyst composition of the present invention prepared by using an alcohol and a tertiary amine compound in combination was used, the decrease of the reactivity after storage was small as compared with Comparative Example 4 in which an alcohol, which is contained in the amine catalyst composition of the present invention, was not used. Further, in Example 24, as compared with Comparative Example 4, there was no change of the foam density, and the outer appearance and the degree of cell coarsening of the obtained rigid polyurethane foam were within favorable ranges.

Further, Examples in which an aromatic polyester polyol was used instead of the polyether polyol used in Examples 21 to 23 will be described.

In Examples 25 to 27 in which the amine catalyst composition of the present invention prepared by using an alcohol and a tertiary amine compound in combination was used, the rate of decrease of the reactivity after storage was so small as at most 30% as compared with Comparative Example 5 in which an alcohol, which is contained in the amine catalyst composition of the present invention, was not used.

The present invention was described in detail with reference to specific embodiments, however, it is obvious to those skilled in the art that various changes and modifications are possible without departing from the scope of the present invention.

The entire disclosure of Japanese Patent Application No. 2016-098772 filed on May 17, 2016 including specification, claims, drawings and summary is incorporated herein by reference in its entirety.

### INDUSTRIAL APPLICABILITY

In production of a polyurethane foam using a hydrohaloolefin as a blowing agent, the catalyst composition of the present invention, which has high catalytic activity, can exhibit sufficient reactivity even with a small addition amount. Further, the storage stability of a polyol blended liquid containing the amine catalyst composition of the present invention remarkably improves as compared with a conventional catalyst composition. Accordingly, the catalyst composition of the present invention is particularly expected to be used as a catalyst composition for producing a polyurethane foam containing a hydrohaloolefin as a blowing agent.

1. A catalyst composition for producing a polyurethane foam, comprising one or at least two alcohols selected from the group consisting of an alcohol represented by the following formula (1):
R¹—OH (1)
wherein R¹ is a C₅₋₂₀ unsaturated hydrocarbon group having at least one double bond, a C₆, C₈, C₁₀ or C₁₂ linear alkyl group, or a C₁₂₋₂₄ branched alkyl group, and an alcohol represented by the following formula (2): 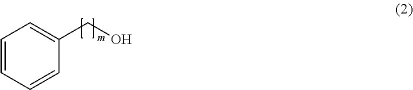
wherein m is from 1 to 4,
and one or at least two tertiary amine compounds selected from the group consisting of hexamethyltriethylenetetramine, N,N,N′-trimethylaminoethylethanolamine, N,N-dimethylaminoethoxyethanol, N,N-dimethyl-N′,N′-di(2-hydroxypropyl)propylenediamine, N,N,N′-trimethyl-N′-(2-hydroxyethyl)bis(2-aminoethyl) ether and N,N-dimethylaminoethyl-N′-methylaminoethyl-N″-methylaminoisopropanol.

2. The catalyst composition according to claim 1, wherein R¹ in the formula (1) is a C₅, C₁₀ or C₁₈ unsaturated hydrocarbon group having at least one double bond.

3. The catalyst composition according to claim 1, wherein the alcohol represented by the formula (1) is at least one member selected from the group consisting of oleyl alcohol, linoleyl alcohol, linolenyl alcohol, prenol, linalool, α-terpineol, 1-hexanol, 1-octanol, 1-decanol, lauryl alcohol, 2-butyloctanol, 2-hexyldecanol, stearyl alcohol, isostearyl alcohol, 2-octyldecanol, 2-octyldodecanol, isoeicosanol and 2-decyltetradecanol.

4. The catalyst composition according to claim 1, wherein the alcohol represented by the formula (1) is at least one member selected from the group consisting of oleyl alcohol, linoleyl alcohol, linolenyl alcohol, 1-octanol, 1-decanol, lauryl alcohol, 2-hexyldecanol, isostearyl alcohol, 2-octyldodecanol, isoeicosanol and 2-decyltetradecanol.

5. The catalyst composition according to claim 1, wherein the alcohol represented by the formula (1) is at least one member selected from the group consisting of oleyl alcohol, 1-decanol, lauryl alcohol, isostearyl alcohol, isoeicosanol and 2-decyltetradecanol.

6. The catalyst composition according to claim 1, wherein the alcohol represented by the formula (2) is benzyl alcohol.

7. The catalyst composition according to claim 1, wherein the tertiary amine compound is one or at least two compounds selected from the group consisting of hexamethyltriethylenetetramine, N,N,N′-trimethylaminoethylethanolamine and N,N-dimethylaminoethoxyethanol.

8. The catalyst composition according to claim 1, wherein the tertiary amine compound is one or two compounds selected from the group consisting of hexamethyltriethylenetetramine and N,N,N′-trimethylaminoethylethanolamine.

9. A polyol blended liquid composition for producing a polyurethane foam, which comprises a polyol, a hydrohaloolefin and the catalyst composition as defined in claim 1.

10. The polyol blended liquid composition according to claim 9, wherein the hydrohaloolefin is a fluoroalkene or chloroalkene having 3 or 4 carbon atoms.

11. The polyol blended liquid composition according to claim 9, wherein the hydrohaloolefin is one or at least two members selected from the group consisting of trifluoropropene, tetrafluoropropene, pentafluoropropene, chlorodifluoropropene, chlorotrifluoropropene and chlorotetrafluoropropene.

12. The polyol blended liquid composition according to claim 9, wherein the hydrohaloolefin is one or at least two compounds selected from the group consisting of 1,3,3,3-tetrafluoropropene, 1,1,3,3-tetrafluoropropene, 1,2,3,3,3-pentafluoropropene, 1,1,1-trifluoropropene, 1,1,1,3,3-pentafluoropropene, 1,1,1,3,3,3-hexafluorobut-2-ene, 1,1,2,3,3-pentafluoropropene, 1,1,1,2,3-pentafluoropropene, 1-chloro-3,3,3-trifluoropropene, 1,1,1,4,4,4-hexafluorobut-2-ene, and their structural isomers, geometric isomers and stereoisomers.

13. The polyol blended liquid composition according to claim 9, wherein the polyol is at least one member selected from the group consisting of a polyether and a polyester polyol, having an average hydroxy value of from 200 to 800 mgKOH/g.

14. A method for producing a polyurethane foam, which comprises reacting the polyol blended liquid composition as defined in claim 9, and a polyisocyanate.
